(19) United States
(12) Patent Application Publication
(10) Pub. No.: US 2023/0421454 A1
(43) Pub. Date: Dec. 28, 2023

(54) NON-TRANSITORY COMPUTER-READABLE RECORDING MEDIUM STORING PROGRAM AND RESOURCE ALLOCATION METHOD

(71) Applicant: Fujitsu Limited, Kawasaki-shi (JP)

(72) Inventor: Shingo OKUNO, Kawasaki (JP)

(73) Assignee: Fujitsu Limited, Kawasaki-shi (JP)

(21) Appl. No.: 18/180,889

(22) Filed: Mar. 9, 2023

(30) Foreign Application Priority Data
Jun. 24, 2022 (JP) 2022-101562

(51) Int. Cl. H04L 41/122; G06F 9/455; G06F 9/50

(52) U.S. Cl. CPC H04L 41/122; G06F 9/45558; G06F 9/5038; G06F 2009/45583

(57) ABSTRACT

A computer acquires performance information that indicates a first resource amount, which is a resource amount of processor resources allocated to a virtual node and which corresponds to when a data transfer amount per unit time between the processor resources and a memory is a first data transfer amount. The computer reduces, when processor resources corresponding to a second resource amount larger than the first resource amount are allocated to a first virtual node being executed in a physical node, the processor resources of the first virtual node by using the first resource amount as a lower limit. The computer allocates processor resources obtained by the reduction to a second virtual node that has not yet been executed in the physical node, to execute the second virtual node in the physical node.

### CROSS-REFERENCE TO RELATED APPLICATION

This application is based upon and claims the benefit of priority of the prior Japanese Patent Application No. 2022-101562, filed on Jun. 24, 2022, the entire contents of which are incorporated herein by reference.

### FIELD

The embodiments discussed herein relate to a computer-readable recording medium storing a program and to a resource allocation method.

### BACKGROUND

There are cases in which an information processing system uses computer virtualization technology to cause a physical node to execute at least one virtual node. The virtual node may be a virtual machine in a narrow sense with a guest operating system (OS). Alternatively, the virtual node may be a container without a guest OS. Part of the hardware resources of the physical node is allocated to the virtual node. The hardware resources allocated to the virtual node include processor resources.

There is proposed a resource management system in which a container is generated, whether the available resources included in a resource pool satisfy the resource requirements of the container is determined, and the container is activated if the resource requirements are satisfied. There is also proposed a virtual resource scheduler that deploys a virtual machine on a host computer based on the available resource amount of the host computer and that deploys a container on a virtual machine based on a set resource amount of the virtual machine.

There is also proposed an information processing system in which scale-out is performed to increase the number of containers if the load of a certain kind of container has increased and in which scale-in is performed to reduce the number of containers if the load of a certain kind of container has decreased. There is also proposed a storage system in which the usage of shared resources by an individual physical node is monitored. In this storage system, a node in which a new virtual machine or a new container is to be deployed is determined such that the usage amount of the resources will not exceed its upper limit.

See, for example, U.S. Pat. No. 7,814,491, Publication of U.S. Patent Application No. 2016/0378563, Japanese Laid-open Patent Publication No. 2018-160149, and Japanese Laid-open Patent Publication No. 2022-3577.

### SUMMARY

According to one aspect, there is provided a non-transitory computer-readable recording medium storing therein a computer program that causes a computer to execute a process including: acquiring performance information that indicates a first resource amount, which is a resource amount of processor resources allocated to a virtual node and which corresponds to when a data transfer amount per unit time between the processor resources and a memory is a first data transfer amount; reducing, when processor resources corresponding to a second resource amount larger than the first resource amount are allocated to a first virtual node being executed in a physical node, the processor resources of the first virtual node by using the first resource amount as a lower limit; and allocating processor resources obtained by the reducing to a second virtual node that has not yet been executed in the physical node, to execute the second virtual node in the physical node.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates an example of an information processing system according to a second embodiment;

FIG. 3 is a block diagram illustrating a hardware example of a management server;

FIG. 4 is a block diagram illustrating a configuration example of a processor;

FIG. 5 is a block diagram illustrating a configuration example of a virtual node environment;

FIG. 6 illustrates an example of how a node in which a container is to be deployed is selected;

FIG. 7 is a graph illustrating an example of a relationship between the number of cores and a memory bandwidth;

FIG. 8 illustrates an example of how the number of allocated cores is reduced;

FIG. 9 is a block diagram illustrating functional examples of the management server and nodes;

FIG. 10 illustrates an example of a container table;

FIG. 11 is a flowchart illustrating an example of a procedure of generation of a performance model; and

FIG. 12 is a flowchart illustrating an example of a procedure of execution of a container.

### DESCRIPTION OF EMBODIMENTS

There are cases in which a virtual node processes a large amount of data. In these cases, if more processor resources are allocated to the virtual node, the data transfer amount per unit time between the allocated processor resources and a memory tends to increase, whereby faster data processing is expected. However, if an excessively large number of processor resources are allocated to the virtual node, a memory access conflict, etc. could occur. As a result, the data transfer amount will not increase as expected. This is a state in which the memory access is a bottleneck and processor resources that are not effectively used are allocated to the virtual node. In this case, the number of virtual nodes executable in the corresponding physical node could be reduced.

The following embodiments will be described with reference to the accompanying drawings.

### First Embodiment

A first embodiment will be described.

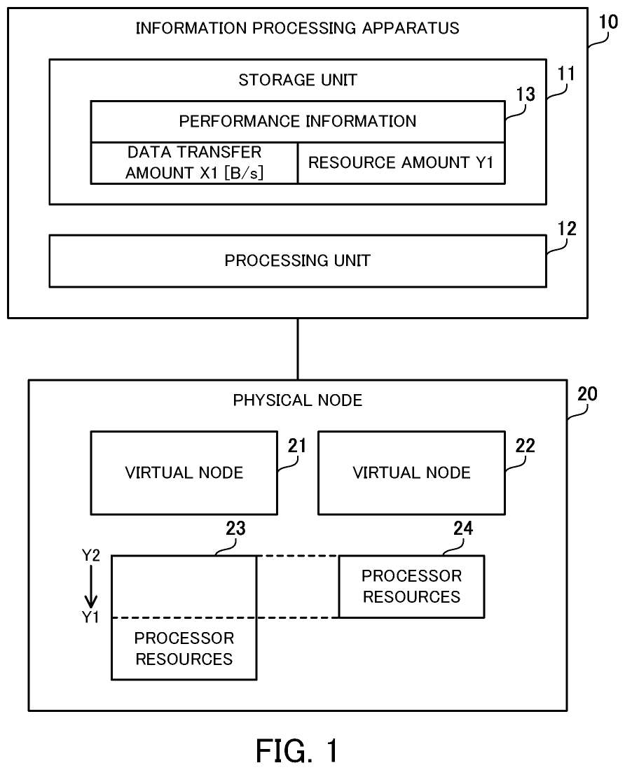

FIG. 1 illustrates an information processing apparatus according to the first embodiment.

This information processing apparatus 10 allocates processor resources of a physical node 20 to virtual nodes and controls execution of the virtual nodes. The information processing apparatus 10 may be a client apparatus or a server apparatus. The information processing apparatus 10 may be referred to as a computer, a resource allocation apparatus, or a virtual node management apparatus. The physical node 20 is, for example, a server apparatus. The physical node 20 may be referred to as a computer, an information processing apparatus, or simply a node. The information processing apparatus 10 and the physical node 20 may be configured as the same apparatus.

The information processing apparatus 10 includes a storage unit 11 and a processing unit 12. The storage unit 11 may be a volatile semiconductor memory such as a random-access memory (RAM) or a nonvolatile storage such as a hard disk drive (HDD) or a flash memory. The processing unit 12 is, for example, a processor such as a central processing unit (CPU), a graphics processing unit (GPU), or a digital signal processor (DSP). The processing unit 12 may include an electronic circuit such as an application specific integrated circuit (ASIC) or a field programmable gate array (FPGA). The processor executes a program stored in a memory such as a RAM (which may also be the storage unit 11), for example. A group of processors may be referred to as a multiprocessor or simply a “processor.”

The storage unit 11 stores performance information 13 that indicates a first resource amount (a resource amount Y1). The resource amount is the amount of processor resources allocated to a virtual node. The resource amount is, for example, the number of processor cores. The processor cores may be physical cores or logical cores. The virtual node is a virtual computer defined by computer virtualization technology. The virtual node is activated in response to a request from a user, for example. The virtual node may be a virtual machine in a narrow sense with a guest OS or may be a container without a guest OS. The first resource amount indicated by the performance information 13 is a resource amount corresponding to when the data transfer amount is a first data transfer amount (a data transfer amount X1).

The data transfer amount is the amount of data transferred between the processor resources allocated to the virtual node and a memory per unit time. The data transfer amount may be referred to as a memory bandwidth. The memory is, for example, a shared memory accessed by all the processor resources (for example, a plurality of processor cores) allocated to the virtual node. The memory may be a main memory such as a RAM or a cache memory such as a level 3 (L3) cache memory or a last level cache (LLC) memory. The data transfer amount may include the amount of data read from the memory per unit time and the amount of data written in the memory per unit time.

The actual data transfer amount of the virtual node may be measured by an operating system such as a guest OS or a host OS. There are cases in which the virtual node executes an application that processes a large amount of data. In these cases, if more processor resources are allocated to the virtual node, the data transfer amount of the virtual node is increased by parallel memory access or the like, and as a result, faster data processing is achieved. However, if the processor resources to be used are sufficiently increased, for example, because of the physical limit of a memory bus or an access conflict among the processor resources (for example, among the processor cores), the data transfer amount could stop increasing proportionally. Thus, even when more processor resources are allocated to the virtual node, the memory access could become a bottleneck and some of the allocated processor resources could not be effectively used.

The performance information 13 may be generated based on the above relationship between the data transfer amount and the resource amount. The first data transfer amount is a data transfer amount used as a reference. The first data transfer amount may correspond to the lower limit of the data transfer amount allowed by the virtual node, and the first resource amount indicated by the performance information 13 may be the minimum resource amount to achieve the lower-limit data transfer amount. In addition, depending on the application, the above relationship between the data transfer amount and the resource amount may differ. Thus, the storage unit 11 may store the performance information per virtual node. For example, the performance information 13 is the performance information of a virtual node 21, which will be described below.

In FIG. 1, the performance information 13 is information in which the correspondence between the first data transfer amount and the first resource amount is indicated. Alternatively, the performance information 13 may be information in which a plurality of data transfer amounts are associated with a plurality of resource amounts. The information processing apparatus 10 may cause a different physical node other than the physical node 20 to execute a virtual node on a trial basis, to measure a plurality of data transfer amounts corresponding to a plurality of resource amounts. The information processing apparatus 10 may generate the performance information 13 based on the result of this measurement. The information processing apparatus 10 may determine the above first data transfer amount from a data transfer amount corresponding to a resource amount desired by a user. For example, the first data transfer amount is 70% of a data transfer amount corresponding to a desired resource amount. The user may specify the first data transfer amount.

The processing unit 12 detects that processor resources 23 corresponding to a second resource amount (a resource amount Y2) larger than the first resource amount indicated by the performance information 13 are allocated to the virtual node 21 being executed in the physical node 20. The second resource amount is, for example, a resource amount specified by the user of the virtual node 21. Next, the processing unit 12 reduces the processor resources 23 of the virtual node 21 by using the first resource amount as the lower limit. As a result, processor resources 24, which constitute part of the processor resources 23, become available resources.

Next, by allocating the processor resources 24 to a virtual node 22 that has not yet been executed in the physical node 20, the processing unit 12 causes the physical node 20 to execute the virtual node 22. The reduction of the processor resources 23 may be performed if the physical node 20 lacks the processor resources for executing the virtual node 22. For example, if the physical node 20 lacks the processor resources for executing the virtual node 22, the virtual node 22 could be set in a standby state. In this case, the reduction of the processor resources 23 may be performed. The resource amount of the processor resources 24 obtained by the reduction may correspond to the deficiency. As a result, the virtual node 21 and the virtual node 22 are executed simultaneously in the physical node 20.

As described above, the information processing apparatus 10 according to the first embodiment detects that processor resources corresponding to the second resource amount larger than the first resource amount for achieving a certain data transfer amount are allocated to the virtual node 21. Next, the information processing apparatus 10 reduces the processor resources of the virtual node 21 by using the first resource amount as the lower limit. By allocating the processor resources obtained by the reduction to the virtual node 22 that has not yet been executed, the information processing apparatus 10 is able to cause the physical node 20 to execute the virtual node 22 in addition to the virtual node 21.

As a result, of all the processor resources allocated to the virtual node 21, processor resources that have not been effectively used because of the memory access being a bottleneck are released and allocated to the virtual node 22 that has not yet been executed. In this way, the processor resources are effectively used, and more virtual nodes are executed simultaneously in the physical node 20. In addition, since at least the first resource amount corresponding to the certain data transfer amount is ensured for the virtual node 21, the performance of the virtual node 21 is maintained within its allowable range.

The information processing apparatus 10 may allow a different physical node to measure a plurality of data transfer amounts corresponding to a plurality of resource amounts by using the virtual node 21 and may generate the performance information 13 based on the result of this measurement. In this way, the first resource amount suitably matching the application of the virtual node 21 is determined. In addition, the information processing apparatus 10 may determine the first data transfer amount from the second data transfer amount corresponding to the second resource amount. As a result, the first data transfer amount allowed by the virtual node 21 is determined.

In addition, the information processing apparatus 10 may reduce the processor resources of the virtual node 21 only when the physical node 20 lacks the processor resources for executing the virtual node 22. In this way, the balance between the performance of the virtual node 21 and the use of the processor resources of the physical node 20 is maintained. In addition, the resource amount may be the number of processor cores, and the memory related to the data transfer amount may be a shared memory accessed by the processor cores in parallel. In this way, the information processing apparatus 10 is able to allocate the processor cores effectively while preventing the data transfer between the plurality of processor cores and the shared memory from becoming a bottleneck.

### Second Embodiment

Next, a second embodiment will be described.

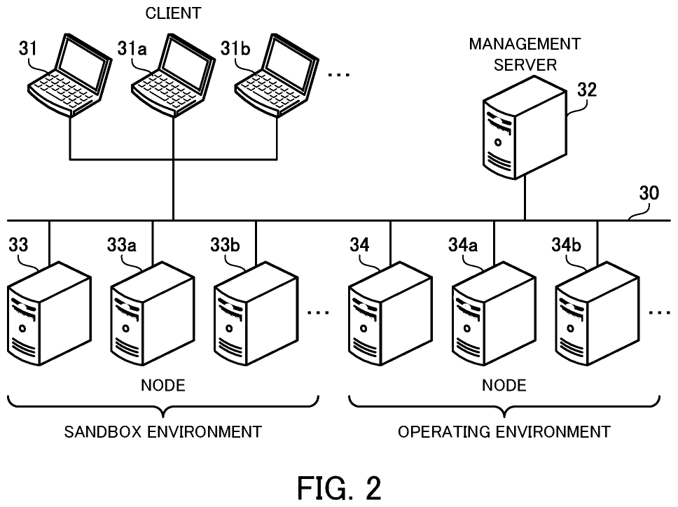

FIG. 2 illustrates an example of an information processing system according to a second embodiment.

The information processing system according to the second embodiment generates a container, which is a lightweight virtual computer without a guest OS, by using container virtualization technology. The information processing system deploys the container in a node in response to a request from a client and transmits a data processing result of the container to the client. Note that the information processing system is also able to generate a virtual machine with a guest OS by using server virtualization technology and to deploy the virtual machine in a node. The information processing system may be implemented by using a data center or a cloud system.

The information processing system includes a plurality of clients including clients 31, 31a, and 31b, a management server 32, and a plurality of nodes including nodes 33, 33a, 33b, 34, 34a, and 34b. The plurality of clients, the management server 32, and the plurality of nodes are connected to a network 30. The network 30 may include a local area network (LAN) or a wide area network such as the Internet. The management server 32 corresponds to the information processing apparatus 10 according to the first embodiment. The node 34 corresponds to the physical node 20 according to the first embodiment.

The clients 31, 31a, and 31b are client computers used by users. The clients 31, 31a, and 31b each transmit a container execution request to the management server 32. The container execution request specifies a file path to a container program or a maximum execution time. The container execution request also specifies the resource amount of hardware resources allocated to a container. The resource amount includes the number of processor cores allocated to the container and the capacity of the memory allocated to the container. The resource amount may include different resource amounts other than the number of cores and the memory capacity, such as the capacity of an auxiliary storage device. In principle, the hardware resources corresponding to the specified resource amount are allocated to the container that is generated in response to a container execution request. The clients 31, 31a, and 31b receive data processing results of their respective containers from the management server 32.

The management server 32 is a server computer that controls deployment of containers in the nodes 33, 33a, 33b, 34, 34a, and 34b. The nodes 33, 33a, and 33b are server computers that execute containers for a certain time on a trial basis and that belong to a sandbox environment. In the sandbox environment, performance models, which will be described below, are generated. The nodes 34, 34a, and 34b are server computers that officially execute containers and that belong to an operating environment. These nodes belonging to the operating environment are able to execute a plurality of containers simultaneously.

In response to a request from any one of the clients 31, 31a, and 31b, the management server 32 selects one of the nodes belonging to the operating environment and allocates hardware resources of the selected node to a container, to deploy the container in the selected node. The selected node is a node having available processor cores corresponding to the number of cores specified by the corresponding requesting user and an available memory area corresponding to the memory capacity specified by the user. The node continues to execute the container until the application of the container terminates or until the maximum execution time specified by the user elapses.

In addition, the management server 32 selects an available one of the nodes belonging to the sandbox environment and causes the selected node to execute a container having the same program as that of the container to be deployed in the operating environment only for a short time on a trial basis. It is preferable that the node in the sandbox environment execute only one container at a time. The node measures a memory bandwidth, which will be described below, while executing the container and generates a performance model corresponding to the container.

If none of the nodes in the operating environment have the available processor cores with which a new container indicated by a container execution request is deployable, the management server 32 may create the available processor cores by reducing the number of cores of at least one of the existing containers. In this case, the management server 32 refers to the performance models generated by using the sandbox environment. In addition, the management server 32 monitors the containers deployed in the operating environment. Upon completion of a container, the management server 32 transmits a data processing result of the container to the corresponding requesting client.

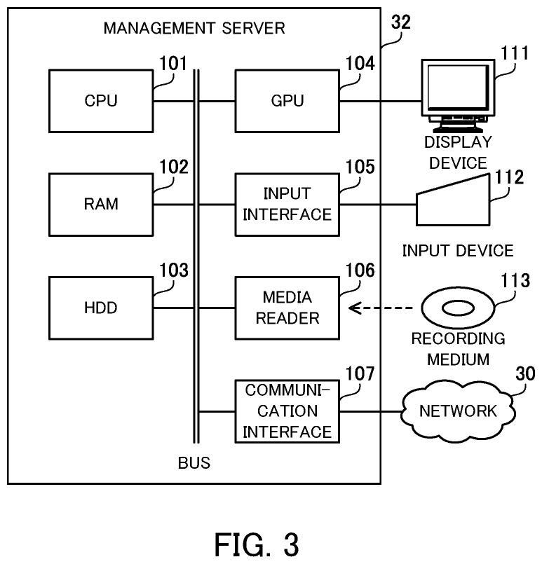

FIG. 3 is a block diagram illustrating a hardware example of the management server.

The management server 32 includes a CPU 101, a RAM 102, an HDD 103, a GPU 104, an input interface 105, a media reader 106, and a communication interface 107, which are connected to a bus. The CPU 101 corresponds to the processing unit 12 according to the first embodiment. The RAM 102 or the HDD 103 corresponds to the storage unit 11 according to the first embodiment. The clients 31, 31a, and 31b and the nodes 33, 33a, 33b, 34, 34a, and 34b may have hardware equivalent to that of the management server 32.

The CPU 101 is a processor that executes program instructions. The CPU 101 loads a program and data stored in the HDD 103 to the RAM 102 and executes the program. The management server 32 may include a plurality of processors.

The RAM 102 is a volatile semiconductor memory that temporarily stores a program executed by the CPU 101 and data used by the CPU 101 for calculation. The management server 32 may include a different kind of volatile memory other than a RAM.

The HDD 103 is a nonvolatile storage that stores an operating system, middleware, software programs such as application software, and data. The management server 32 may include a different kind of nonvolatile storage such as a flash memory or a solid-state drive (SSD).

The GPU 104 performs image processing in coordination with the CPU 101 and outputs an image to a display device 111 connected to the management server 32. Examples of the display device 111 include a cathode ray tube (CRT) display, a liquid crystal display, an organic electro-luminescence (EL) display, and a projector. A different kind of output device such as a printer may be connected to the management server 32. The GPU 104 may be used as a general-purpose computing on graphics processing unit (GPGPU). The GPU 104 may execute a program in response to an instruction from the CPU 101. The management server 32 may include a volatile semiconductor memory other than the RAM 102 as a GPU memory.

The input interface 105 receives an input signal from an input device 112 connected to the management server 32. Examples of the input device 112 include a mouse, a touch panel, and a keyboard. A plurality of input devices may be connected to the management server 32.

The media reader 106 is a reading device that reads out a program and data recorded in a recording medium 113. Examples of the recording medium 113 include a magnetic disk, an optical disc, and a semiconductor memory. Examples of the magnetic disk include a flexible disk (FD) and an HDD. Examples of the optical disc include a compact disc (CD) and a digital versatile disc (DVD). The media reader 106 copies a program and data read out from the recording medium 113 to another recording medium such as the RAM 102 or the HDD 103. This program may be executed by the CPU 101.

The recording medium 113 may be a portable recording medium and may be used for distribution of a program and data. The recording medium 113 and the HDD 103 may each be referred to as a computer-readable recording medium.

The communication interface 107 communicates with other information processing apparatuses such as the clients 31, 31a, and 31b and the nodes 33, 33a, 33b, 34, 34a, and 34b via the network 30. The communication interface 107 may be a wired communication interface connected to a wired communication device such as a switch or a router or may be a wireless communication interface connected to a wireless communication device such as a base station or an access point.

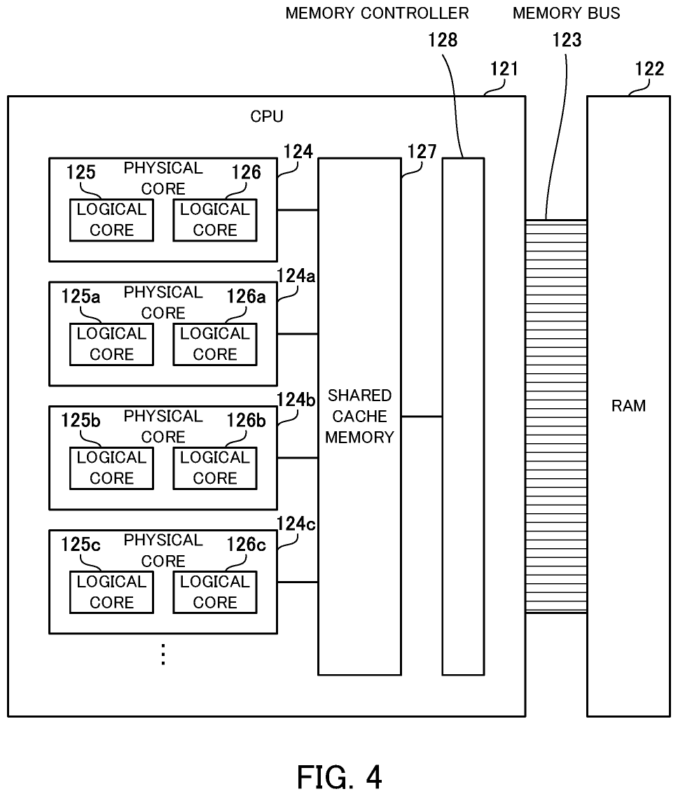

FIG. 4 is a block diagram illustrating a configuration example of a processor.

The node 34 includes a CPU 121 and a RAM 122. The other nodes such as the nodes 33, 33a, 33b, 34a, and 34b include a CPU and a RAM equivalent to those of the node 34. The nodes 33, 33a, 33b, 34, 34a, and 34b each include a RAM of 128 GB, for example. The CPU 121 and the RAM 122 are connected to each other by a memory bus 123. The memory bus 123 transfers data read out from the RAM 122 to the CPU 121 or data written from the CPU 121 in the RAM 122. The memory bus 123 has a physical memory bandwidth as the upper limit of the data transfer amount per unit time.

The CPU 121 includes a plurality of physical cores including physical cores 124, 124a, 124b, and 124c, a shared cache memory 127, and a memory controller 128. Each physical core includes at least one logical core. For example, each physical core includes two logical cores. The individual logical core may be referred to as a hardware thread. The physical core 124 includes logical cores 125 and 126. The physical core 124a includes logical cores 125a and 126a. The physical core 124b includes logical cores 125b and 126b. The physical core 124c includes logical cores 125c and 126c.

The individual physical core includes an instruction pipeline for executing program instructions and a register group for temporarily storing data. The instruction pipeline includes a circuit corresponding to a plurality of stages such as instruction fetch, instruction decode, instruction execution, and write-back. The two logical cores included in one physical core share the corresponding instruction pipeline and register group. If an idle time occurs in the pipeline processing performed by one logical core, the other logical core may perform. pipeline processing by using the idle instruction pipeline.

There are cases in which the operating system recognizes a logical core as one processor core. The number of processor cores allocated to a container may be the number of physical cores or the number of logical cores. Each of the nodes 33, 33a, 33b, 34, 34a, and 34b includes, for example, 64 physical cores or logical cores.

The shared cache memory 127 is a cache memory shared by the plurality of physical cores of the CPU 121. The shared cache memory 127 is an LLC, which is a cache memory that is the closest to the RAM 122 and is an L3 cache memory, for example. The shared cache memory 127 temporarily stores a copy of part of the data stored in the RAM 122. Data used by different physical cores coexists in the shared cache memory 127. A level 1 (L1) cache memory and a level 2 (L2) cache memory are included in and occupied by a physical core.

The memory controller 128 controls the data transfer between the shared cache memory 127 and the RAM 122. When requested for data that is not stored in the shared cache memory 127, the memory controller 128 copies the requested data from the RAM 122 to the shared cache memory 127. In this case, there are cases in which the memory controller 128 creates an available area, for example, by writing back data stored in the shared cache memory 127 to the RAM 122.

According to the second embodiment, a memory bandwidth is measured per container. Of the entire physical memory bandwidth of the RAM 122, the memory bandwidth of a container is the data transfer amount per unit time generated in response to requests from the processor cores allocated to the container. Information about the memory bandwidth of a container may be acquired from the corresponding operating system or software called a profiler. Instead of the memory bandwidth of a container, the cache memory bandwidth of the container may be used. Of the entire physical cache memory bandwidth of the shared cache memory 127, the cache memory bandwidth of a container is the data transfer amount per unit time generated in response to requests from the processor cores allocated to the container. Information about the cache memory bandwidth of the container may be acquired from the corresponding operating system or software called a profiler.

For example, the memory bandwidth of a container is calculated by measuring, for a certain time, the amount of data read from and written to the RAM 122 in response to requests from the processor cores allocated to the container and dividing the amount by the certain time to convert the amount into the data transfer amount per second. For example, the cache memory bandwidth of the container is calculated by measuring, for a certain time, the amount of data read from and written to the shared cache memory 127 in response to requests from the processor cores allocated to the container and dividing the amount by the certain time to convert the amount into the data transfer amount per second.

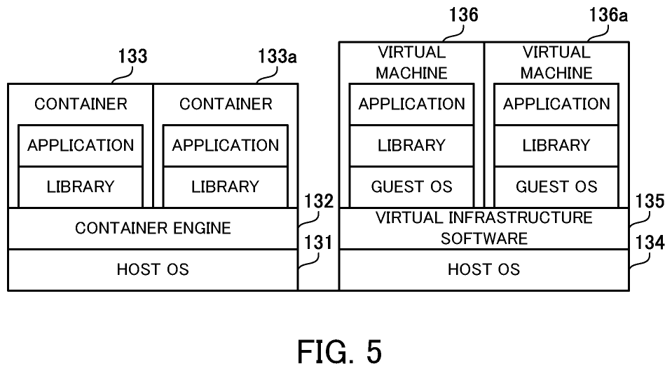

FIG. 5 is a block diagram illustrating a configuration example of a virtual node environment.

The node 34 executes a host OS 131 and a container engine 132. The other nodes such as the nodes 33, 33a, 33b, 34a, and 34b also execute software equivalent to that of the node 34. The host OS 131 is an operating system that manages the hardware resources of the node 34. The memory bandwidth or the cache memory bandwidth of the container may be measured by the host OS 131 or other software such as a profiler. The container engine 132 is control software that controls execution of a container such that the host OS 131 views the container as one process. The container engine 132 is executed on the host OS 131.

At least one container can be deployable on the container engine 132. In the example in FIG. 5, containers 133 and 133a are deployed on the container engine 132. Each of the containers 133 and 133a includes a library and an application. The library is middleware used for execution of the application. The library may include a thread parallel library for executing at least one thread by using the hardware resources allocated to the container. The application is an application program indicating processing of the thread executed under control of the library.

As described above, the node 34 may execute a virtual machine instead of a container. In this case, the node 34 executes a host OS 134 and a virtual infrastructure software 135. The host OS 134 is an operating system that manages the hardware resources of the node 34. The virtual infrastructure software 135 is control software that controls execution of a virtual machine and that is executed on the host OS 134.

At least one virtual machine can be deployable on the virtual infrastructure software 135. In the example in FIG. 5, virtual machines 136 and 136a are deployed on the virtual infrastructure software 135. Each of the virtual machines 136 and 136a includes a guest OS, a library, and an application. The guest OS is an operating system that manages the hardware resources allocated to the virtual machine. The memory bandwidth or the cache memory bandwidth of the virtual machine may be measured by the host OS 134 or the guest OS. The library is control software for executing at least one process on the guest OS. The application is an application program executed under control of the guest OS.

Next, deployment of a container in a node in the operating environment will be described.

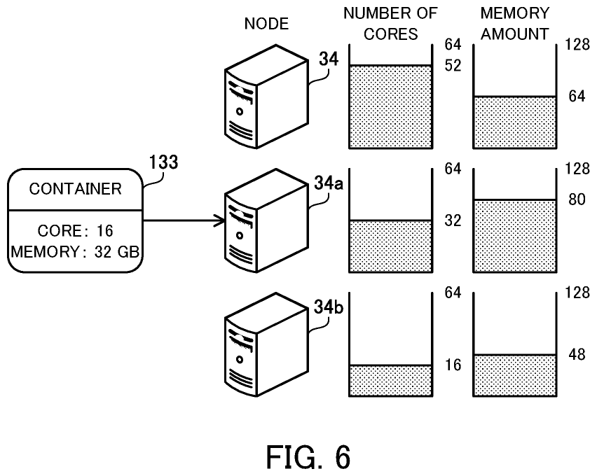

FIG. 6 illustrates an example of how a node in which a container is to be deployed is selected.

The management server 32 uses a bin packing algorithm to select a node in which a container is to be deployed from the nodes in the operating environment. For example, the management server 32 uses a Best-Fit Decreasing (BFD) algorithm. The BFD algorithm selects a node having the minimum available resource amount from the nodes having available resources that are equal to or more than the requested resource amount.

The following example assumes that the management server 32 deploys the container 133 in one of the nodes 34, 34a, and 34b. In the node 34, 52 of the 64 cores are being used, and a memory area of 64 GB of the 128 GB is being used. In the node 34a, 32 of the 64 cores are being used, and a memory area of 80 GB of the 128 GB is being used. In the node 34b, 16 of the 64 cores are being used, and a memory area of 48 GB of the 128 GB is being used. In this situation, the container 133 requests 16 cores and a memory area of 32 GB.

In this case, the node 34 does not have sufficient available processor cores for executing the container 133. Thus, the management server 32 does not select the node 34. The nodes 34a and 34b each have sufficient available processor cores and a sufficient available memory area for executing the container 133. When the available number of cores and the available memory capacity of the node 34a are compared with those of the node 34b, the available number of cores and the available memory capacity of the node 34a are less. Therefore, the management server 32 deploys the container 133 in the node 34a.

As described above, upon receiving a container execution request, the management server 32 allocates processor cores corresponding to the number of cores specified by the corresponding client to the container. However, there are cases in which the memory bandwidth becomes a bottleneck and all the allocated processor cores are not used effectively. Next, the relationship between the memory bandwidth and the number of cores of a container will be described.

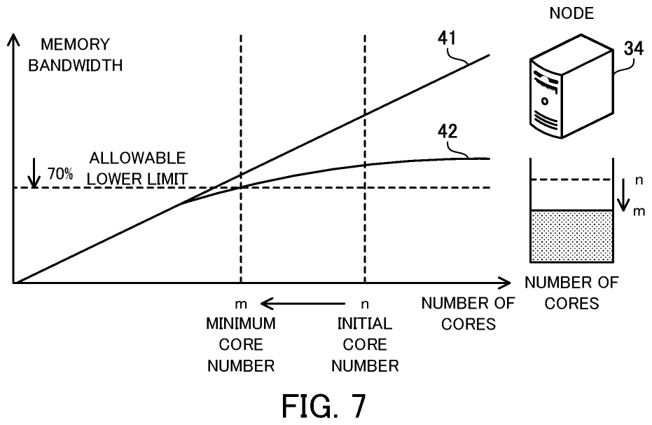

FIG. 7 is a graph illustrating an example of the relationship between the number of cores and the memory bandwidth.

In the case of a container that executes an application that processes a large amount of data, if more processor cores are allocated, the parallelism of the memory access increases further, and the memory bandwidth of the container tends to increase further. When the number of cores is small, the memory bandwidth proportional to the number of cores is achieved. A straight line 41 in FIG. 7 indicates an ideal memory bandwidth proportional to the number of cores.

However, if the number of cores of the container increases, the memory access performed via the memory bus 123 becomes a bottleneck, and only a memory bandwidth smaller than the ideal memory bandwidth indicated by the straight line 41 is achieved. A greater number of cores results in a greater deviation from the ideal memory bandwidth. The memory bandwidth of the container finally converges to a limit, and further increasing the number of cores will not achieve a memory bandwidth greater than the limit. A curve 42 in FIG. 7 indicates an measured memory bandwidth.

There are cases in which the memory bandwidth of a container converges when the memory access amount from a plurality of processor cores reaches the limit of the physical memory bandwidth of the memory bus 123. In addition, there are cases in which the memory bandwidth of a container converges when the probability that the memory accesses of a plurality of processor cores collide with each other increases and the memory access latency time increases.

If the memory bandwidth becomes a bottleneck, even if more processor cores are allocated to the container, because the memory access latency time increases, parallel processing is not effectively performed by the plurality of processor cores, that is, the data processing speed is not improved as expected. Thus, since the container uselessly occupies the processor cores that are not being used effectively, the number of containers deployable per node could be reduced. Thus, when the number of processor cores in the operating environment is insufficient, the management server 32 reduces the number of cores of at least one existing container from a specified number of cores while preventing significant reduction in memory bandwidth.

First, the relationship between the memory bandwidth and the number of cores as illustrated by the curve 42 differs depending on the application executed by the container. For this reason, a node (the node 33 in this case, for example) in the sandbox environment executes a container on a trial basis only for a short time. The node 33 measures the memory bandwidth of the container while gradually increasing the number of processor cores allocated to the container. As a result, the curve 42 corresponding to the container is calculated.

Based on the curve 42, the node 33 determines an initial memory bandwidth corresponding to an initial core number n specified by the corresponding client. The node 33 calculates a certain percentage of the determined initial memory bandwidth as the allowable lower limit. The certain percentage is, for example, 70%. Based on the curve 42, the node 33 determines the number of cores corresponding to the allowable lower limit as a minimum core number m.

The minimum core number m is the lower limit of the number of cores allowed by the container in view of the memory bandwidth, which could become a bottleneck. When the number of processor cores in the operating environment is insufficient and a new container is in a standby state, the number of cores of an existing container could be reduced by using the minimum core number m as the lower limit. For example, when an existing container is deployed in the node 34, there is a case in which reducing the number of cores of the existing container from n to m makes it possible to deploy a new container in the node 34. In this case, the new container is added to the node 34 by reducing the number of cores of the existing container. In this way, the processor cores are used effectively, and more containers are performed simultaneously.

In the above description, the node 33 calculates the allowable lower limit of the memory bandwidth based on the curve 42. However, the client may specify the allowable lower limit. In this case, the node 33 determines the number of cores corresponding to the specified allowable lower limit as the minimum core number m. In a database, which will be described below, the minimum core number m may be recorded or information corresponding to the curve 42, that is, the measured values of a plurality of memory bandwidths corresponding to a plurality of core numbers, may be recorded.

Alternatively, a node in the sandbox environment or the management server 32 may analyze the measured values of the memory bandwidths and determine the minimum core number m per container. The “performance model,” which will be described below, may be information indicating the minimum core number m per container or information indicating correspondence relationships between a plurality of core numbers and a plurality of memory bandwidths. The vertical axis in FIG. 7 may represent the cache memory bandwidth instead of the memory bandwidth.

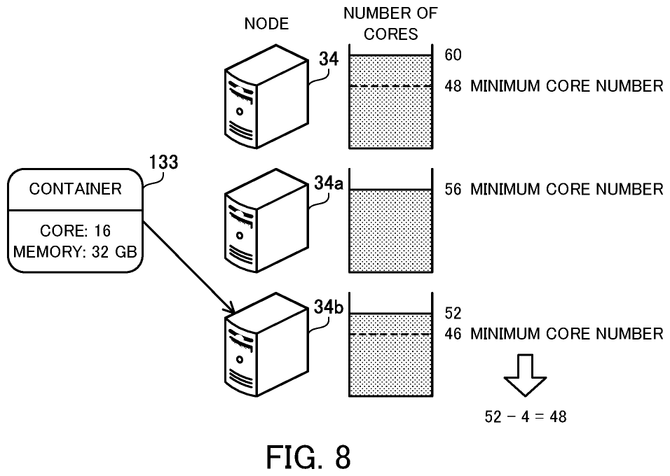

FIG. 8 illustrates an example of how the number of allocated cores is reduced.

The following example assumes that the management server 32 deploys the container 133 in one of the nodes 34, 34a, and 34b. The container 133 requests 16 cores. In the node 34, 60 of the 64 cores are being used. In the node 34a, 56 of the 64 cores are being used. In the node 34b, 52 of the 64 cores are being used. In this state, none of the nodes are able to execute the container 133. Thus, the management server 32 refers to the performance models of the existing containers being executed in the nodes 34, 34a, and 34b and determines how many processor cores are allowed to be available.

A sum of minimum core numbers of the existing containers deployed in the node 34 is 48. Thus, the management server 32 is able to reduce the number of cores of the existing containers in the node 34 by up to 12 and to increase the available core number to 16. A sum of minimum core numbers of the existing containers deployed in the node 34a is 56. Thus, the management server 32 determines that there are no available cores in the node 34a. A sum of minimum core numbers of the existing containers deployed in the node 34b is 46. Thus, the management server 32 is able to reduce the number of cores of the existing containers in the node 34b by up to 6 and to increase the available core number to 18.

The management server 32 determines a node in which the container 133 is deployable in view of the minimum core number. In this case, the container 133 is deployable in the node 34 or 34b. The management server 32 calculates, for each of the determined nodes 34 and 34b, how many processor cores need to be reduced to deploy the container 133, and selects the node 34 or 34b whose reduction number is less than that of the other node.

In the case of the node 34, to increase the available core number to 16, the currently-used processor cores of the node 34 need to be reduced by 12. In the case of the node 34b, to increase the available core number to 16, the currently-used processor cores of the node 34b need to be reduced by 4. In the case of the node 34b, although it is possible to increase the available core number up to 18, only the minimum number of cores for deploying the container 133 need to be reduced from the existing containers. Thus, the management server 32 selects the node 34b and reduces the number of cores of the existing containers of the node 34b to 48. Next, the management server 32 allocates 16 available processor cores of the node 34b to the container 133 and causes the node 34b to execute the container 133.

In the above example, the management server 32 selects the node whose reduction number is less than that of the other node and reduces the number of cores. However, alternatively, priorities may previously be set for the containers, regarding the number of cores to be reduced. These priorities may be determined based on the container importance levels specified by clients. Alternatively, based on the maximum execution times specified by clients, the management server 32 may preferentially reduce the number of cores of a container having the shortest remaining execution time.

If the selected node is executing a plurality of containers, the management server 32 may reduce the cores of the plurality of containers in proportion to their respective initial core numbers or current core numbers. Alternatively, among the plurality of containers, the management server 32 may reduce the number of cores of a container having the highest priority first. After the management server 32 reduces the number of cores of a certain container, if available processor cores are created in the operating environment upon completion of another container, the management server 32 may increase the number of cores of the certain container to the initial core number of the certain container.

When the container 133 is deployed in the node 34b, if the memory area is also insufficient, the management server 32 may reduce the memory capacity of the existing containers of the node 34b. For example, the management server 32 may reduce the memory capacity of the containers in proportion to the processor core reduction number.

The performance model of a certain container may be generated before or after this container is deployed in the operating environment. The memory bandwidth of the container could vary during execution of the container. Therefore, the management server 32 may update the performance model by using the sandbox environment during execution of the container.

Next, a functional example and a processing procedure of the information processing system will be described.

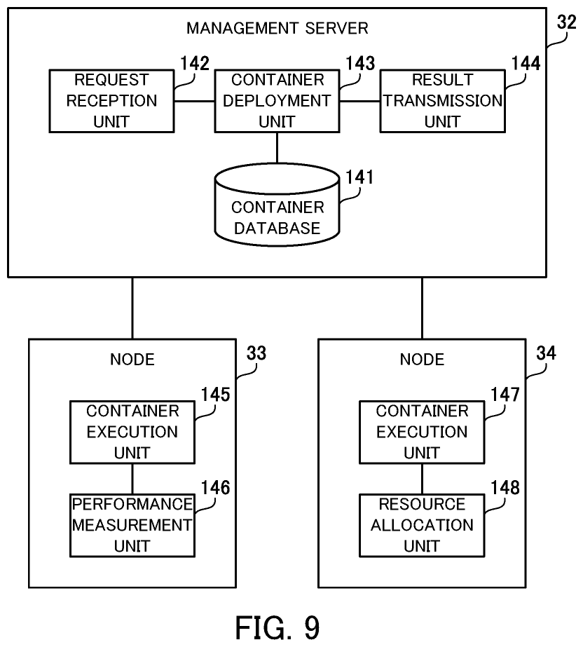

FIG. 9 is a block diagram illustrating a functional example of the management server and nodes.

The management server 32 includes a container database 141, a request reception unit 142, a container deployment unit 143, and a result transmission unit 144. The container database 141 is implemented by using, for example, the RAM 102 or the HDD 103. The request reception unit 142, the container deployment unit 143, and the result transmission unit 144 are each implemented by using, for example, the CPU 101, the communication interface 107, and a program.

The container database 141 stores a container table for managing containers. The structure of the container table will be described below. The container table includes a performance model per container. Each performance model is written from a node in the sandbox environment. The container database 141 may be stored outside the management server 32. For example, the information processing system includes a database server holding the container database 141.

The request reception unit 142 receives container execution requests from the clients 31, 31a, and 31b. The request reception unit 142 stores the received container execution requests in a queue. About a container execution request included in the queue, the request reception unit 142 selects an available node from the sandbox environment, deploys a container in the selected available node, and causes this node to generate a performance model.

The container deployment unit 143 extracts the container execution requests one by one from the top of the queue and searches the operating environment for a node in which the container is deployable, the node having an available resource amount sufficient for the resource amount specified by the container execution request. If the container deployment unit 143 finds a suitable node, the container deployment unit 143 allocates the available resources to the container and causes this node to execute the container. If the container deployment unit 143 does not find a suitable node, the container deployment unit 143 waits until any of the existing containers terminates and the available resources increase.

However, if the insufficient hardware resources are processor cores, the container deployment unit 143 refers to the container database 141 and determines whether to reduce the number of cores of at least one existing container. If reducing the number of cores makes it possible for a node to deploy the container, the container deployment unit 143 reduces the number of cores of at least one of the existing containers and allocates the available resources obtained thereby to the new container.

The result transmission unit 144 monitors the containers being executed in the nodes in the operating environment. A container may terminate upon completion of its data processing or may forcibly terminate when a maximum execution time specified by the corresponding container execution request elapses. When any one of the containers terminates, the result transmission unit 144 reads out a data processing result generated by this container and transfers the data processing result to the client that has transmitted the container execution request. In some cases, the data processing result is stored in the node in which this container has been deployed, and in other cases, the data processing result is stored in a certain file server outside this node.

The node 33 includes a container execution unit 145 and a performance measurement unit 146. The container execution unit 145 and the performance measurement unit 146 are each implemented by, for example, a CPU and a program. The nodes 33a and 33b also include modules equivalent to those of the node 33.

The container execution unit 145 executes a container specified by the management server 32 only for a certain time on a trial basis. The container execution unit 145 gradually increases the number of processor cores allocated to the container while executing the container. For example, the container execution unit 145 increases the number of cores from 1 to 64 by one by one. Alternatively, the container execution unit 145 may gradually reduce the number of processor cores allocated to the container.

While the container execution unit 145 is executing the container, the performance measurement unit 146 measures the memory bandwidth per core number. For example, the performance measurement unit 146 acquires information about the memory bandwidth of the container from the host OS of the node 33. The performance measurement unit 146 determines the minimum core number from the relationship between a plurality of core numbers and a plurality of memory bandwidths. Alternatively, the management server 32 may determine the minimum core number. The performance measurement unit 146 generates information about the minimum core number or information indicating the relationship between the number of cores and the memory bandwidth as a performance model and stores the performance model in the container database 141.

The node 34 includes a container execution unit 147 and a resource allocation unit 148. The container execution unit 147 and the resource allocation unit 148 are each implemented by, for example, a CPU and a program. The nodes 34a and 34b include modules equivalent to those of the node 34.

The container execution unit 147 executes a container specified by the management server 32 by using hardware resources specified by the resource allocation unit 148. The container execution unit 147 terminates the container when a maximum execution time specified by the management server 32 elapses. The resource allocation unit 148 allocates available resources of the node 34 that match the resource amount specified by the management server 32 to the new container. When the container terminates, the resource allocation unit 148 releases the hardware resources, which have been allocated to the terminated container. In addition, the resource allocation unit 148 may reduce the number of processor cores allocated to a container being executed in response to an instruction from the management server 32.

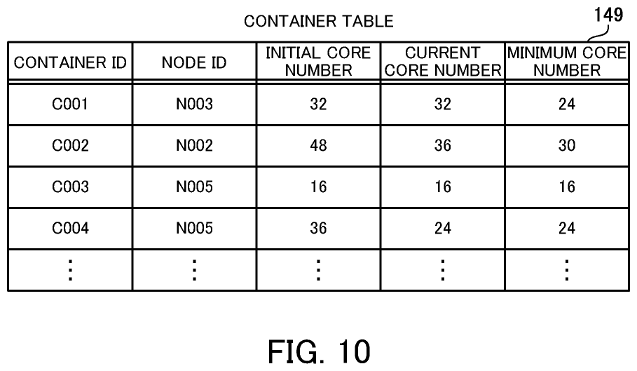

FIG. 10 illustrates an example of the container table.

This container table 149 is stored in the container database 141. The container table 149 stores a plurality of records corresponding to a plurality of containers that have not yet been executed completely. These uncompleted containers include containers being executed in the operating environment and containers that have not yet been deployed in the operating environment. Each record includes a container ID, a node ID, an initial core number, a current core number, and a minimum core number.

The container ID is an identifier that identifies a container. A container ID is issued per container execution request. The node ID is an identifier that identifies a node in which a container is deployed and which belongs to the operating environment. If no containers are deployed in the operating environment, no information may be stored as the individual node ID. The initial core number is the number of cores specified in the corresponding container execution request.

The current core number is the number of processor cores currently allocated to the corresponding container. The current core number is between the corresponding minimum core number and the corresponding initial core number, inclusive. If no containers are deployed in the operating environment, no information may be stored as the individual current core number. The minimum core number is the number of cores corresponding to the allowable lower limit of the memory bandwidth determined by using the sandbox environment. If the minimum core number has not yet been determined, no information may be stored as the minimum core number. The minimum core number may be updated while the container is being executed in the operating environment.

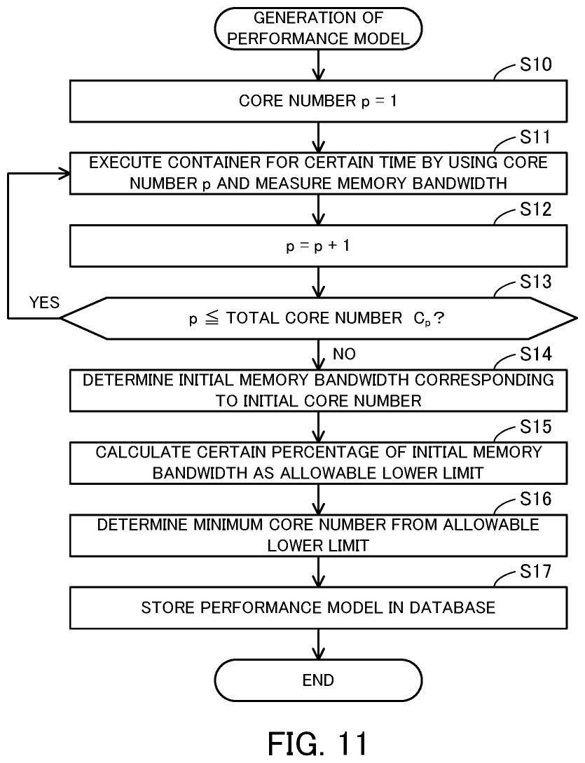

FIG. 11 is a flowchart illustrating an example of a procedure of generation of a performance model.

(S10) The performance measurement unit 146 sets a core number p to 1.

(S11) The container execution unit 145 executes a container for a certain time by using the core number p. The performance measurement unit 146 measures the memory bandwidth of the container corresponding to the core number p.

(S12) The performance measurement unit 146 increases the core number p by 1.

(S13) The performance measurement unit 146 determines whether the current core number p is equal to or less than a total core number Cₚ of the CPU of the node 33. If p is equal to or less than Cₚ, the processing returns to step S11. If p is more than Cₚ, the processing proceeds to step S14.

(S14) The performance measurement unit 146 determines the initial memory bandwidth corresponding to the initial core number specified by the corresponding client based on the measurement results of the memory bandwidths.

(S15) From the determined initial memory bandwidth, the performance measurement unit 146 calculates the allowable lower limit of the memory bandwidth. For example, the performance measurement unit 146 calculates a certain percentage (for example, 70%) of the initial memory bandwidth as the allowable lower limit. If the allowable lower limit has already been specified by the client, the performance measurement unit 146 uses this specified allowable lower limit.

(S16) The performance measurement unit 146 determines the core number corresponding to the allowable lower limit as the minimum core number of this container based on the measurement results of the memory bandwidths.

(S17) The performance measurement unit 146 stores a performance model indicating the determined minimum core number in the container database 141. The performance model may include the measured values of a plurality of memory bandwidths corresponding to a plurality of core numbers. Alternatively, the management server 32 may determine the minimum core number by analyzing the relationship between the core numbers and the memory bandwidths.

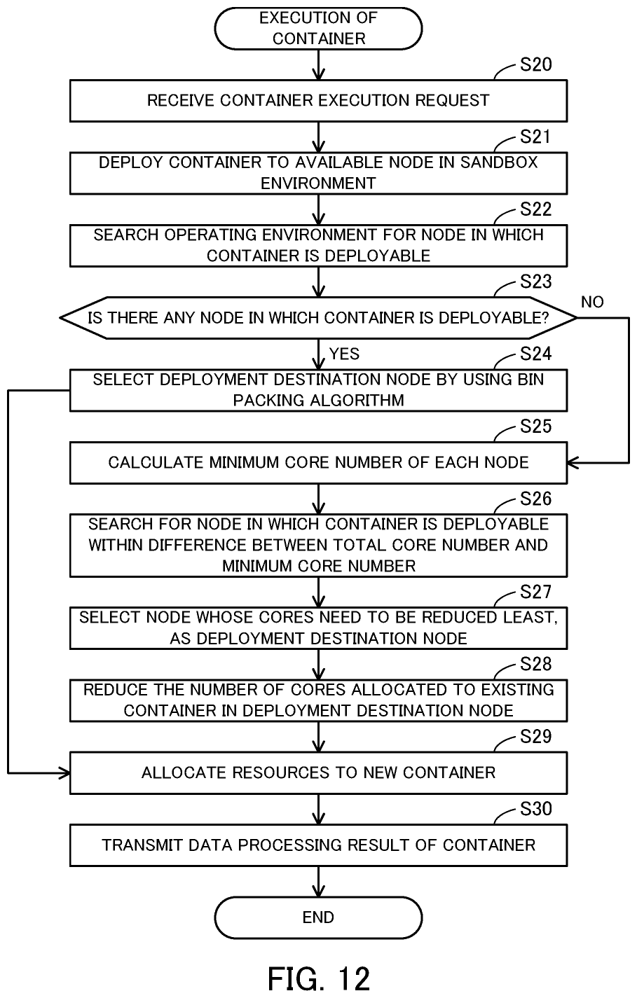

FIG. 12 is a flowchart illustrating an example of a procedure of execution of a container.

(S20) The request reception unit 142 receives a container execution request.

(S21) The request reception unit 142 selects an available node from the sandbox environment and deploys a new container indicated by the container execution request in the selected available node on a trial basis. As a result, a performance model is generated in accordance with the flowchart in FIG. 11.

(S22) The container deployment unit 143 searches the operating environment for a node in which the container is deployable, the container having available resources sufficient for the resource amount specified in the container execution request. This node in which the container is deployable is a node having available processor cores sufficient for the specified number of cores and an available memory area sufficient for the specified memory capacity.

(S23) The container deployment unit 143 determines whether there is at least one node in which the container is deployable at the moment. If there is a suitable node in which the container is deployable, the processing proceeds to step S24. If there is no suitable node in which the container is deployable, the processing proceeds to step S25.

(S24) The container deployment unit 143 uses a bin packing algorithm to select a deployment destination node in which the new container is to be deployed from the nodes in which the new container is deployable. For example, from the nodes in which the new container is deployable, the container deployment unit 143 selects a node having the least number of available processor cores. Next, the processing proceeds to step S29.

(S25) The container deployment unit 143 calculates the minimum core numbers of the nodes in the operating environment, based on the minimum core numbers of the existing containers stored in the container database 141. The minimum core number of a node is a sum of minimum core numbers of the existing containers being executed in this node.

(S26) The container deployment unit 143 searches for a node in which the container is deployable within the difference between the total core number of the CPU and the minimum core number calculated in step S25. If the difference between the total core number and the minimum core number of a node is equal to or more than the specified number of cores of the new container, this node is determined as a node in which the container is deployable.

(S27) From the nodes in which the container is deployable, the container deployment unit 143 selects a node whose cores need to be reduced the least to deploy the new container, as the deployment destination node. The number of cores to be reduced is expressed by “the number of cores being used−(the total number of cores−the specified number of cores).” If the container deployment unit 143 finds no node in which the container is deployable, the container deployment unit 143 may return the container execution request to the queue. In this case, the container deployment unit 143 may wait until a node in which the container is deployable appears or until the container deployment unit 143 creates a node in which the container is deployable by reducing the number of cores.

(S28) The container deployment unit 143 reduces the number of cores allocated to an existing container being executed in the selected deployment destination node and instructs the deployment destination node to change its resource allocation.

(S29) The container deployment unit 143 allocates the hardware resources of the selected deployment destination node to the new container and instructs the deployment destination node to start execution of the container. The processor cores corresponding to the number of cores specified in the container execution request and the memory area corresponding to the memory capacity specified in the container execution request are allocated to the new container.

(S30) The result transmission unit 144 monitors the containers deployed in the operating environment. Upon completion of a container, the result transmission unit 144 acquires a data processing result of the container and transmits the data processing result to the client that has transmitted the corresponding container execution request.

As described above, in the information processing system according to the second embodiment, in principle, hardware resources corresponding to a resource amount specified by a user are allocated to a container, and a data processing result obtained as a result of execution of this container is transmitted to the user. In this way, an application that has high processing load, e.g., an application that processes a large amount of data, is efficiently executed.

In addition, in the information processing system, when the number of available processor cores is insufficient, the number of cores of at least one existing container is reduced, and the cores obtained by this reduction are allocated to a new container. In this way, more containers are executed simultaneously, and thus, the limited hardware resources are efficiently used. In addition, the number of cores may be reduced up to the number of cores that corresponds to the allowable lower limit of the memory bandwidth. In this way, the data processing capability of the container is maintained within its allowable range. In addition, the number of processor cores that undergo an extended latency time as a result of the memory bandwidth being a bottleneck is reduced. That is, the processor cores are efficiently used. In addition, the allowable lower limit is calculated and the minimum core number is determined per container. As a result, a suitable minimum core number that matches the memory access tendency of a container is determined.

In addition, in the information processing system, if none of the nodes have sufficient available processor cores, a node whose cores need to be reduced the least to deploy a new container is selected. In this way, the data processing capability of the individual existing container is deteriorated less.

In one aspect, processor resources are efficiently used in a virtual node environment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring performance information that indicates a first resource amount, which is a resource amount of processor resources allocated to a virtual node and which corresponds to when a data transfer amount per unit time between the processor resources and a memory is a first data transfer amount;
reducing, when processor resources corresponding to a second resource amount larger than the first resource amount are allocated to a first virtual node being executed in a physical node, the processor resources of the first virtual node by using the first resource amount as a lower limit; and
allocating processor resources obtained by the reducing to a second virtual node that has not yet been executed in the physical node, to execute the second virtual node in the physical node.

2. The non-transitory computer-readable recording medium according to claim 1, wherein the process further includes causing a different physical node to measure a plurality of data transfer amounts corresponding to a plurality of resource amounts by using the first virtual node and generating the performance information based on a relationship between the plurality of data transfer amounts and the plurality of resource amounts.

3. The non-transitory computer-readable recording medium according to claim 1, wherein the process further includes determining the first data transfer amount based on a second data transfer amount corresponding to the second resource amount.

4. The non-transitory computer-readable recording medium according to claim 1, wherein the reducing is performed when the physical node lacks processor resources for executing the second virtual node.

5. The non-transitory computer-readable recording medium according to claim 1, wherein the resource amount of the processor resources allocated to the virtual node is the number of allocated processor cores, and the memory is a shared memory accessed by the allocated processor cores in parallel.

6. A resource allocation method comprising:
acquiring, by a processor, performance information that indicates a first resource amount, which is a resource amount of processor resources allocated to a virtual node and which corresponds to when a data transfer amount per unit time between the processor resources and a memory is a first data transfer amount;
reducing, by the processor, when processor resources corresponding to a second resource amount larger than the first resource amount are allocated to a first virtual node being executed in a physical node, the processor resources of the first virtual node by using the first resource amount as a lower limit; and
allocating, by the processor, processor resources obtained by the reducing to a second virtual node that has not yet been executed in the physical node, to execute the second virtual node in the physical node.
